(19) United States
(12) Patent Application Publication
(10) Pub. No.: US 2006/0123220 A1
(43) Pub. Date: Jun. 8, 2006

(54) Speech recognition in BIOS

(75) Inventor: James C. Colson, Austin, TX (US)

Correspondence Address: IBM CORP (WSM);C/O WINSTEAD SECHREST & MINICK P.C., PO BOX 50784, DALLAS, TX, 75201, US

(73) Assignee: International Business Machines Corporation, Armonk, NY (US)

(21) Appl. No.: 11/002,520

(22) Filed: Dec. 2, 2004

(51) Int. Cl. G06F 9/00

(52) U.S. Cl. 713/1

(57) ABSTRACT

A computer system has firmware used to configure hardware of the system or execute functions for generating user outputs from the system without loading an operating system. The firmware has a voice command recognition engine for accepting voice command data from a microphone and microphone circuitry. Recognized voice commands are used to generate response data that is converted to voice response data in a voice response engine. On power-up, a time window is generated when requests to interact with the firmware are considered. If a voiced command requesting interaction with the firmware is received, then the voice command engine and the voice response engine are enabled to interact with the firmware. If a key stroke or a mouse click command is received requesting interaction with the firmware is received, then firmware interaction proceeds normally. Other firmware functions may be executed by either voiced commands or by normal commands.

### TECHNICAL FIELD

The present invention relates in general to methods and systems to improve accessibility options for accessibility impaired individuals when using, modifying, or testing computer systems.

### BACKGROUND INFORMATION

Basic Input Output System (BIOS) is an essential set of routines in a personal computer (PC), which is stored on a chip and provides an interface between the operating system and the hardware. The BIOS supports all peripheral technologies and internal services such as the real-time clock (time and date). On startup, the BIOS tests the system and prepares the computer for operation by querying its own small memory (CMOS) bank for drive and other configuration settings. It searches for other BIOSs on the plug-in boards and sets up pointers (interrupt vectors) in memory to access those routines. It then loads the operating system and passes control to it. The BIOS accepts requests from the drivers as well as the application programs. BIOSs must periodically be updated to keep pace with new peripheral technologies. If the BIOS is stored on a read only memory (ROM) chip (ROM BIOS), it must be replaced. Newer BIOSs are stored on a flash memory chip that can be upgraded via software.

As PCs become more widely used, accessibility for handicapped individuals is becoming more important. While there are a number of initiatives and inventions around extensions to Operating Systems and Applications to support the visually and mentally impaired using speech technology (both speech recognition and text-to-speech), there has been no corresponding work done on the system firmware that is used to modify the system hardware configuration of interaction protocol (e.g., BIOS).

There are other initiatives to develop augmentation or replacement of BIOS in computer systems. For example, the Extensible Firmware Interface (EFI) in computers with the Intel Itanium® processor is the interface between a computer's firmware, hardware, and the operating system. EFI defines a new partition style called Globally Unique Identifier (GUID) partition table (GPT). GUID is a method for computing object identifiers (OIDs) from Microsoft®. EFI serves the same purpose for Itanium®-based computers as the BIOS found in x86-based computers. However, EFI has expanded capabilities that provide a consistent way to start any compatible operating system and an easy way to add EFI drivers for new bootable devices without the need to update the computer's firmware.

There is, therefore, a need for a system and method that imbeds accessibility options into the firmware that is used to configure hardware operations of a system. This would extend the reach of accessibility impaired individuals to work at all levels of system interaction from using application programs, modifying system configurations hardware, testing systems and higher level system programming.

### SUMMARY OF THE INVENTION

This invention proposes the use of imbedded speech technology as an integral user interface for the use and configuration of BIOS software in PCs. This would allow the visually and mentally impaired users an opportunity to interact with a BIOS of their computer to, for instance, change the boot sequence for different I/O devices, etc. Additionally, it would allow the visually and manually impaired the opportunity to work in a PC manufacturing process to configure and test PCs at the BIOS level, which they currently are not enabled to do. At system power up, an audio and a visual command would be generated indicating a time window in which a request for interacting with the BIOS or other system firmware used to control hardware configuration will be received. If a user utters a corresponding activate voice protocol command, then a voice command recognition engine and a text to voice engine for interfacing with the BIOS are enabled. Interaction with the BIOS is via the voice command recognition engine and the text to voice engine until interaction is terminated with a terminate command. If a user inputs a keyboard or a mouse click command to interact with the BIOS, then the voice command interface for interacting with the BIOS is not activated and normal interaction is enabled until the user terminates BIOS interaction. If no BIOS interaction is enabled or BIOS interaction is terminated, then normal boot up operations proceed after system power up with the BIOS in the power up state.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram of a system with firmware used to modify hardware configuration option for the system;

FIG. 2 is a flow diagram of method steps used in embodiments of the present invention;

FIG. 3 is a flow diagram of method steps used in embodiments of the present invention; and

FIG. 4 is a block diagram of a data processing system suitable for practicing principles of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits may be shown in block diagram form in order not to obscure the present invention in unnecessary detail. For the most part, details concerning timing, data formats within communication protocols, and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

BIOS is a startup routine in a PC that enables users to reconfigure hardware settings that are stored in a small, battery-backed memory bank. Although modem BIOSs can detect new drives and update their settings automatically, older PCs required manual entering of disk parameters after a new drive was installed. All BIOSs enable most users to access their settings at startup. Immediately after turning the machine on, a message is displayed that tells the user which key to press (typically the DEL or F1 key) to enable access to the BIOS code. Many BIOS settings are quite arcane and are usually only changed by experienced technicians. The BIOS setup has also been called the “CMOS setup” or the “CMOS RAM,” because the settings are usually held in a tiny CMOS memory bank in the chip.

In the present invention, system BIOS would be enhanced with imbedded speech technology to enable both speech command recognition inputs and text-to-speech output to be used as an alternate interface to the keyboard and display screen. Typical BIOS systems have a period of time where they expect a key to be pressed during system boot-up in order to perform user interactions with the BIOS. Virtually all PCs now have an integrated speaker and many have been integrated microphones. With speech recognition enhancements, in addition to displaying a notification on the display regarding the entry of the key to enable the BIOS interaction mode, an audible message may be uttered by a text to speech engine detailing to the user which key to press. In the event that microphones are available, the necessary response may be entered via a speech recognition engine during the same period, wherein the utterance of a particular word or phrase by the user may be substituted for a keyboard/mouse input that is expected. Once the BIOS interactive stage is entered or enabled, the BIOS interaction would be speech-enabled in a manner similar to the more conventional operating system functions. Completion of BIOS updating would be indicated either be a keystrokes or via utterance of a specific phrase.

An additional benefit of imbedding a speech command interface is that BIOS companies are adding additional functions at the BIOS to enable quick application interaction without full PC booting to occur. One example is the soon to be available Quick Start package in the Phoenix® BIOS which allows a user to enter the BIOS stage to simply “look” at the Outlook® calendar, without booting the full operating system (OS). BIOS companies like Phoenix® are beginning to make this kind of BIOS extension available to PC manufacturers via the control of the private section of the hard disk allocated for storage of these applications. BIOS companies are also considering allowing the third-party developer community access to the BIOS extension. Additionally, by adding imbedded speech technology in the available Application Programming Interface (API) set for the BIOS developer, these “applications” may be built with accessibility in mind from the beginning.

API is the language and message format used by an application program to communicate with the operating system or some other control program such as a database management system (DBMS) or communications protocol. APIs are implemented by writing function calls in the program, which provide the linkage to the required subroutine for execution. Thus, an API implies that some program module is available in the computer to perform the operation or that it must be linked into the existing program to perform the tasks. Understanding an API is a major part of what a programmer does. Except for writing the business logic that performs the actual data processing, all the rest of the programming is writing the code to communicate with the operating system and other software. The APIs for operating systems can be daunting, especially the calls to display and print. There are more than a thousand API calls in a full-blown operating system such as Windows®, Mac,® or Unix®.

In embodiments of the present invention, the BIOS is speech enabled with a speech recognition engine that receives microphone inputs from the controller for the microphone I/O device. Code in the BIOS is structured to provide accessibility enhancement and not simply to recognize an audible version of the previous keystrokes input for a visual desktop interface. This BIOS interface is designed to interact with an accessibility impaired user by using the audio responses. The present “Windows®” interface with pull down menus, etc. are designed for visual feedback to the user and mouse/keyboard input from the user. While an accessibility impaired user (AIU) using a voice interface may want to accomplish a given result, he/she needs to accomplish it with audio input and an audio feedback. Therefore, the AIU interface protocol is designed to accomplish functions in parallel with normal protocol.

When the system powers up, the BIOS generates an audible output that instructs the AIU of the audible sequences that the AIU needs to generate to accomplish a task that previously was done with mouse/keyboard entries and visual feedback. The AIU interface protocol needs to enable the AIU to navigate through available options when interacting with firmware (for example BIOS) that is used to configure the system hardware. The AIU interface would differ in the same way that a system designed to truly offer voice system operation (without keyboard or mouse) would differ from the present desktop system that is designed for keyboard/mouse and visual feedback. The present invention imbeds a voice recognition engine (voice command recognition engine) which has a limited vocabulary and a speaker independent functionality. The voice command recognition engine would be configured to recognize within the confines of expected commands and not for the general functions of dictation. Likewise, code in the BIOS would be configured to offer an AIU audible directions of how to navigate to accomplish a task. This command sequence would differ from a normal response which might indicate to a user (visually) to select an option which the user can see. The AIU interface would need to direct the AIU with efficient audible commands as to their options.

While the AIU interface may operate in parallel to the normal desktop interface, it does not simply emulate these normal input/outputs. For example, while in the desktop mode, keyboard/mouse operations are simultaneous with display, in the AIU interface protocol it may be necessary to inhibit microphone input while audible outputs are generated.

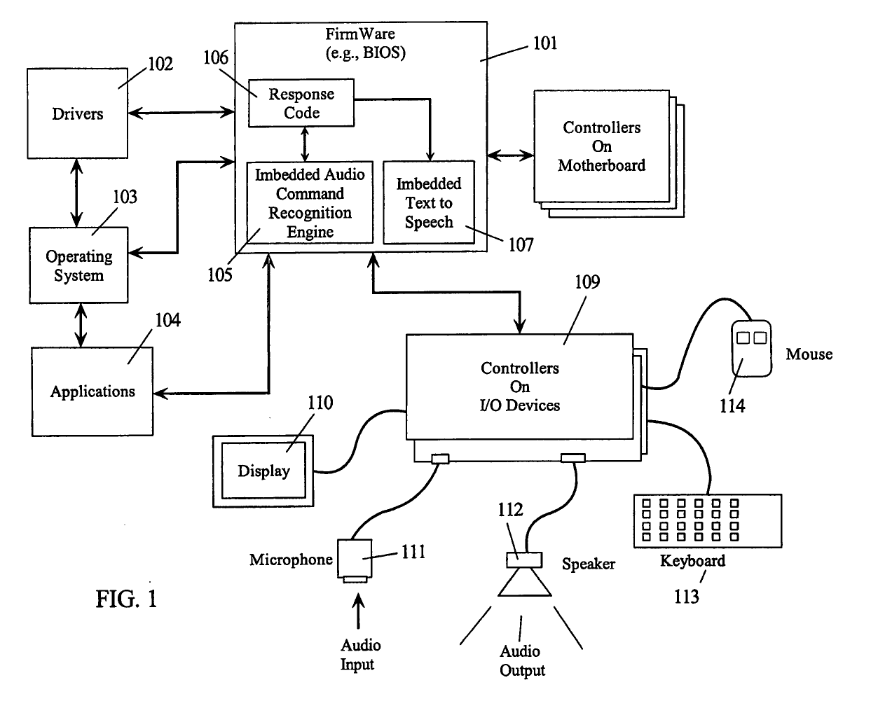

FIG. 1 is a block diagram of an AIU system 100 according to embodiments of the present invention. Firmware 101 contains the imbedded audio command recognition engine 105, imbedded text to speech engine 107, and protocol response code 106. Protocol response code 106 receives recognized commands and generates the appropriate text responses that are converted to speech with text to speech engine 107. Likewise, the protocol response code receives commands from other functions and generates audio commands for the AIU that are not directly the result of an audible command query from the AIU. Firmware (e.g., BIOS) 101 is bi-directionally coupled to device drivers 102, operating system(s) 103, and applications 104. Firmware 101 is also coupled to the controllers on the motherboard 108. Since the firmware 101 is coupled to the controllers for input/output (I/O) devices 109, the imbedded command recognition engine 105 has access to audio data for processing to recognize audio inputs from microphone 111. Likewise, imbedded text to speech engine 107 has access to output audio responses to speaker 112. Display 110, keyboard 113 and mouse 114 are coupled to controllers 109 and are used by application programs 104 or firmware 101 for the non-access-impaired user.

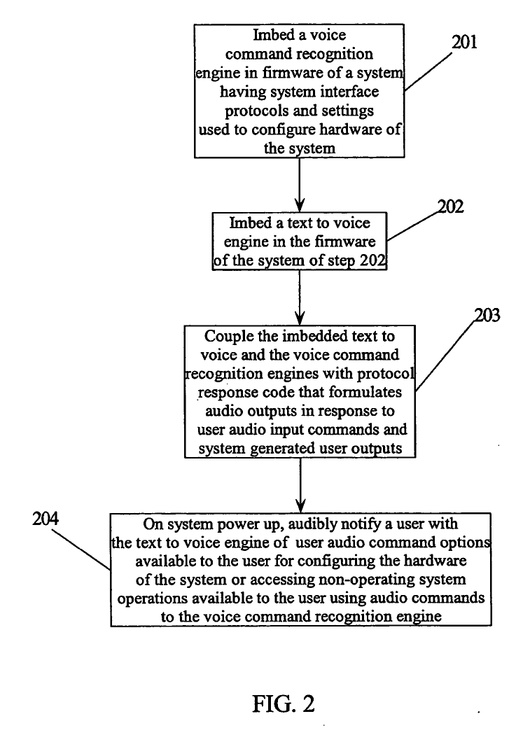

FIG. 2 is a flow diagram of method steps 200 used in embodiments of the present invention. In step 201, a voice command recognition engine is imbedded into firmware of a system having system interface protocols and settings used to configure hardware of the system. In step 202, a text to voice engine is imbedded into the firmware of the system of step 201. In step 203, the text to voice and the voice command recognition engines are coupled with protocol response code that formulates audio outputs, for the text to voice engine, in response to user audio input commands and queries from the voice command recognition engine and system generated user outputs. In step 204, the system audibly notifies the user at power up, with the text to voice engine, of user audio command options available to the user by using the voice command recognition engine, that enable the user to interact with the firmware to modify the system interface protocols and to modify the settings used to configure hardware of the system.

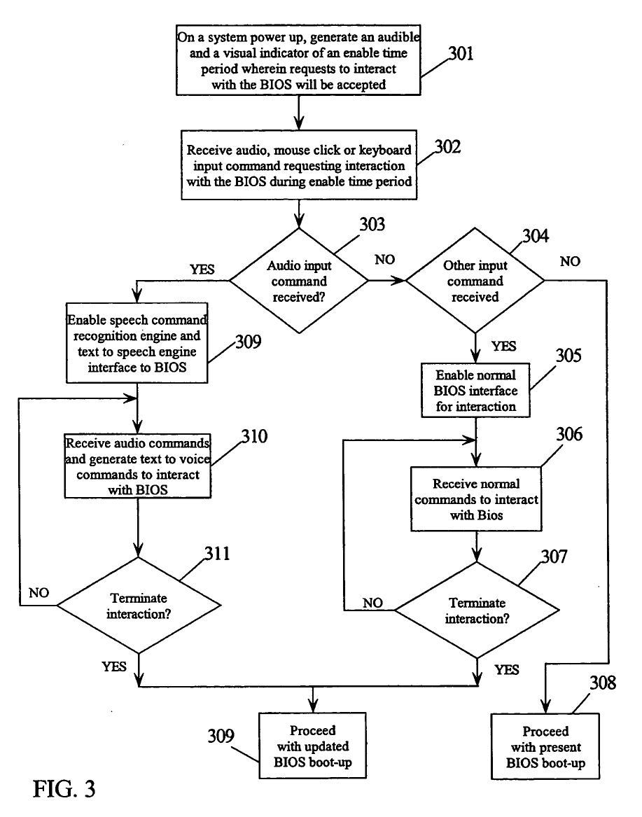

FIG. 3 is a flow diagram of embodiments of the present invention. In step 301, an audible and a visual indicator are generated at power up indicating an enable time period wherein requests to interact with the BIOS or firmware will be accepted. In step 302, audio, mouse click, or keyboard input commands are received requesting interaction with the BIOS during the enable time period. In step 303, a test is done to determine if an audio input command has been received. If the result of the test in step 303 is NO, then in step 304 a test is done to determine if any other input command requesting interaction with the BIOS has been received. If the result of the test in step 304 is NO, then in step 308 present BIOS boot-up sequences are executed. If the result of the test in step 304 is YES, then the normal interface for BIOS interaction is enabled in step 305. In step 306, normal commands to interact with the BIOS are received and normal responses are entered with keyboard or mouse clicks. In step 307, a test is done to determine whether a terminate interaction with BIOS command has been received. If the result of the test in step 307 is NO, then a branch is taken back to step 306. If the result of the test in step 307 is YES, then in step 312 boot-up proceeds with updated BIOS sequences. If the result of the test in step 303 is YES, then the user is requesting to interact with the BIOS using voice commands therefore, in step 309, a voice command recognition engine imbedded in the BIOS is enabled. Likewise in step 309, a voice engine that converts computer commands to voice commands (e.g., text to voice) is also enabled. The voice command recognition engine for inputs and the voice engine for generating voice output responses are linked with code that selects the proper voice output responses for the recognized voice input commands. In step 310, voice input commands and voice output responses are received to interact with the BIOS. In step 311, a test is done to determine if a command to terminate voice interaction with the BIOS has been received. If the result of the test in step 311 is NO, then a branch is taken back to step 310. If the result of the test in step 311 is YES, then in step 312, boot-up using the updated BIOS is executed.

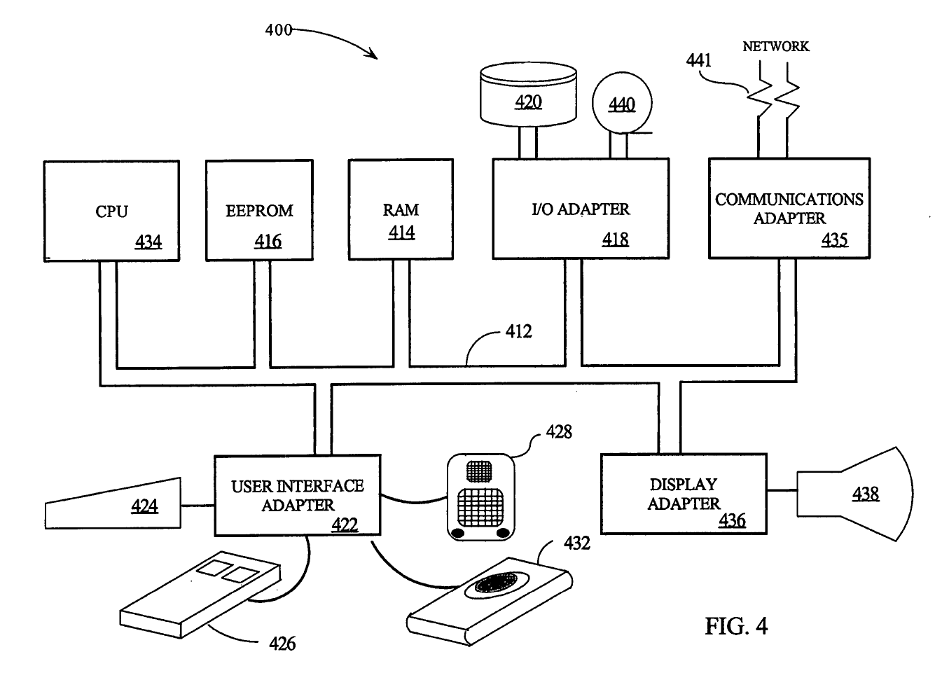

FIG. 4 is a high level functional block diagram of a representative data processing system 400 suitable for practicing the principles of the present invention. Data processing system 400, includes a central processing system (CPU) 410 operating in conjunction with a system bus 412. System bus 412 operates in accordance with a standard bus protocol, such that as the ISA protocol, compatible with CPU 410. CPU 410 operates in conjunction with electronically erasable programmable read-only memory (EEPROM) 416 and random access memory (RAM) 414. Among other things, EEPROM 416 supports storage of the Basic Input Output System (BIOS) data and recovery code. EEPROM 416 also contains all or a part of the code necessary to complete a voice command recognition engine and a voice engine for generating voice responses corresponding to recognized voice commands according to embodiments of the present invention. Code for linking the voice command recognition engine and the voice response engine may also be located in EEPROM 416 or may be loaded from disk 420, tape 440 or from a remote device in response to receiving an input enabling voice command interaction with the BIOS in EEPROM 416. RAM 414 includes, DRAM (Dynamic Random Access Memory) system memory and SRAM (Static Random Access Memory) external cache. I/O Adapter 418 allows for an interconnection between the devices on system bus 412 and external peripherals, such as mass storage devices (e.g., a hard drive, floppy drive or CD/ROM drive), or a printer 440. A peripheral device 420 is, for example, coupled to a peripheral control interface (PCI) bus, and I/O adapter 418, therefore, may be a PCI bus bridge. User interface adapter 422 couples various user input devices, such as a keyboard 424, mouse 426, touch pad 432 or speaker 428 to the processing devices on bus 412. Display 438 which may be, for example, a cathode ray tube (CRT), liquid crystal display (LCD) or similar conventional display units. Display adapter 436 may include, among other things, a conventional display controller and frame buffer memory. Data processing system 400 may be selectively coupled to a computer or telecommunications network 441 through communications adapter 434. Communications adapter 434 may include, for example, a modem for connection to a telecom network and/or hardware and software for connecting to a computer network such as a local area network (LAN) or a wide area network (WAN).

Although the present invention and its advantages have been described in detail, it should be understood that various changes, substitutions and alterations can be made herein without departing from the spirit and scope of the invention as defined by the appended claims.

What is claimed is:

1. A method for modifying firmware used to boot-up a system and configure hardware comprising the steps of:
receiving a request to interact with the firmware as an audio voice enable command during power up of the system; and
enabling voice command interaction with the firmware in response to receipt of the audio voice enable command.

2. The method of claim 1, further comprising the steps of:
receiving audio voice commands from a user of the system and generating compatible voice command data for a voice command recognition engine; and
generating audio voice response outputs for the user of the system with a voice output engine in response to recognized voice commands.

3. The method of claim 2, wherein the voice command recognition engine and the voice output engine are enabled to interact with the firmware when the audio voice enable command is received by the voice command recognition engine within an enable time period for receiving requests to interact with the firmware.

4. The method of claim 3, wherein normal interaction with the firmware is enabled if, during the enable time period, no audio voice enable command is received and a key stroke enable or a mouse click enable command is received.

5. The method of claim 1, wherein the firmware comprises basic input/output system (BIOS) code.

6. The method of claim 1, wherein the firmware comprises Extensible Firmware Interface (EFI) code.

7. The method of claim 2, wherein the compatible voice command data for the voice command recognition engine is remotely coupled to the system on a communication interface.

8. The method of claim 7, wherein the voice response data from the voice output engine is coupled to a user remote from the system on a communication interface.

9. The method of claim 1, wherein the firmware has executable system functions for generating user outputs which do not require loading of an operating system to execute.

10. The method of claim 9, wherein the user outputs are accessed and converted to voice outputs when the audio voice enable command is received during an enable time period and visually displayed when an audio voice enable command is not received during the enable time period.

11. A system with firmware used to set hardware configurations for the system comprising:
a CPU for executing firmware code to boot-up the system;
a recordable storage media for the firmware code coupled to the CPU;
a voice command recognition engine imbedded in the firmware; and
a voice output engine imbedded in the firmware for generating voice response data in response to recognized voice input commands.

12. The system of claim 11 further comprising:
microphone circuitry coupled to a microphone and the voice command recognition engine for receiving audio voice commands from a user of the system and generating compatible voice command data for the voice command recognition engine; and
speaker circuitry coupled to a speaker and the voice output engine for receiving voice output data from the voice output engine and generating voice response outputs for the user of the system in response to recognized voice commands.

13. The system of claim 11, wherein the voice command recognition engine and the voice output engine are enabled to interact with the firmware when the audio voice enable command is received by the voice command recognition engine within an enable time period for receiving requests to interact with the firmware.

14. The system of claim 13, wherein normal interaction with the firmware is enabled if, during the enable time period, no audio voice enable command is received and a key stroke enable or a mouse click enable command is received.

15. The system of claim 11, wherein the firmware comprises basic input/output system (BIOS) code.

16. The system of claim 1 1, wherein the firmware comprises Extensible Firmware Interface (EFI) code.

17. The system of claim 12, wherein the compatible voice command data for the voice command recognition engine is remotely coupled to the system on a communication interface.

18. The system of claim 17, wherein the voice response data from the voice output engine is coupled to a user remote from the system on a communication interface.

19. The system of claim 11, wherein the firmware has executable system functions for generating user outputs which do not require loading of an operating system to execute.

20. The system of claim 19, wherein the user outputs are accessed and converted to voice outputs when the audio voice enable command is received during an enable time period and visually displayed when the audio voice enable command is not received during the enable time period.
